(19) United States
(12) Patent Application Publication
(10) Pub. No.: US 2014/0231372 A1
(43) Pub. Date: Aug. 21, 2014

(54) Modular Display System

(71) Applicants: Lori Mills, Chesterfield, MO (US); David W. Stein, Cincinnati, OH (US); Michael E. Nance, Wyoming, OH (US)

(72) Inventors: Lori Mills, Chesterfield, MO (US); David W. Stein, Cincinnati, OH (US); Michael E. Nance, Wyoming, OH (US)

(21) Appl. No.: 14/185,439

(22) Filed: Feb. 20, 2014

Related U.S. Application Data
(60) Provisional application No. 61/766,726, filed on Feb. 20, 2013.

(51) Int. Cl. B44D 3/12

(52) U.S. Cl. CPC B44D 3/123
USPC 211/85.18

(57) ABSTRACT

A modular display unit, comprising a housing having a front wall, a rear wall, a roof and a floor. The roof slopes downwardly from said rear wall towards said front wall when the display unit is mounted to a vertical wall. A plurality of containers is disposed in a row between the front and rear walls. Each of the containers has a bottom support portion and an open top portion. The open top portion is configured for coupling with a tubular extension for increasing the length of each of the containers. A plurality of pegboard hangers is provided on the rear wall.

### CROSS REFERENCE TO RELATED APPLICATION

This application claims the benefit and priority of U.S. provisional patent application No. 61/766,726, filed on Feb. 20, 2013 and is incorporated herein by reference in its entirety.

### BACKGROUND

Placing artist supplies, such as paint brushes, in closed packaging can be problematic, as artists are tactile-based shoppers. That is, they need to hold, feel and “try” an item before making a purchasing decision. This is extremely important for unique special purpose items, such as brushes with unusual shapes or finishes, and those at higher price points that will be used multiple times. Because of this “hands on” need, open stock paint brushes are often merchandised in open racks that sit on a shelf owned and controlled by a retailer.

Gaining retail placement of open stock (not packaged) artist supplies, such as paint brushes, is a challenge. As there is limited shelf space, retailers have a defined number racks that sit on shelves to accommodate paint brushes, pencils and other artist tools that can stand vertically in a slot or cup. Not only do art suppliers compete with each other for retail shelf space, but the suppliers are typically limited to a single merchandise reset each year, further limiting the opportunity to gain new placement or placement of “off cycle” product introductions.

Another barrier to gaining new product placement in traditional artist's brush racks at retail is that an existing item or “stock keeping unit” (SKU) must be eliminated to make space for a new item. This limits the sales and revenue opportunities of a retailer and creates barriers to new product introduction for a new supplier.

### SUMMARY

The modular display rack disclosed below provides flexibility and modularity to facilitate placement of artist brushes on a pegboard mounted rack across multiple retail formats with dimensional and space limitations varying from store to store. The modular display rack also allows a retailer to customize the display based on the amount of product desired.

The modular display rack disclosed herein solves the above problems by providing a display system that is pegged on pegboard walls to provide flexibility for the retailer and an advantage to a new supplier by allowing a new supplier the opportunity to display its supplies in a way (open stock) that facilitates purchases. The modular aspect of the display system also provides flexibility in the number of items that can be placed in the peg-able area in an orderly, compact and cohesive way.

A modular pegable configuration for a display rack provides an improved system of displaying open stock paint brushes that is integrated into a merchandising section of a store along with other products, thereby enhancing the exposure of artist supplies to consumers. From a retailer's perspective, the display system described herein provides more flexibility in placing new items on pegboards and pegable walls that typically accommodate hanging packages such as cellophane sleeve, blister pack or paperboard based packages. By having a display located outside of the traditional racks, a new supplier has the opportunity to gain placement in special display areas, end caps or integrated with other art products.

A modular display unit for elongated or long rigid artist tools such as paintbrushes, paint mixing tools, paint application tools, drawing or colored pencils and other similarly shaped items include a pegable preformed rack. Each rack or unit, for example, can be provided with six holders, cups or containers to hold or contain articles, space for product descriptions and marketing text, and pegs for attaching to a pegboard wall. Display units can be molded of thin walled plastic, such as by injection molding or blow molding. The display units are modular and can be interlocked side-to-side to create larger display systems with an integrated look. An optional right side paper-based cover panel can also be employed for improved aesthetics by serving as a sidewall and offering additional space for merchandising messaging.

### BRIEF DESCRIPTION OF THE DRAWINGS

In the drawings:

FIG. 1 is a left perspective view of a single modular display unit separated from a modular display system which is formed from two interconnected modular display units;

FIG. 2 is a right rear perspective view of FIG. 1;

FIG. 3 is a side view in longitudinal section of a modular display unit taken along section line 3-3 of FIG. 1 and mounted to a vertical pegboard;

FIG. 4 is a sectioned view across the roofs of a display system taken along section line 4-4 of FIG. 1;

FIG. 5 is a perspective view of a tubular extension platform.; and

FIG. 6 is a perspective view of a wire bracket assembly for holding one or more modular display units on a pegboard.

### DESCRIPTION OF REPRESENTATIVE EMBODIMENTS

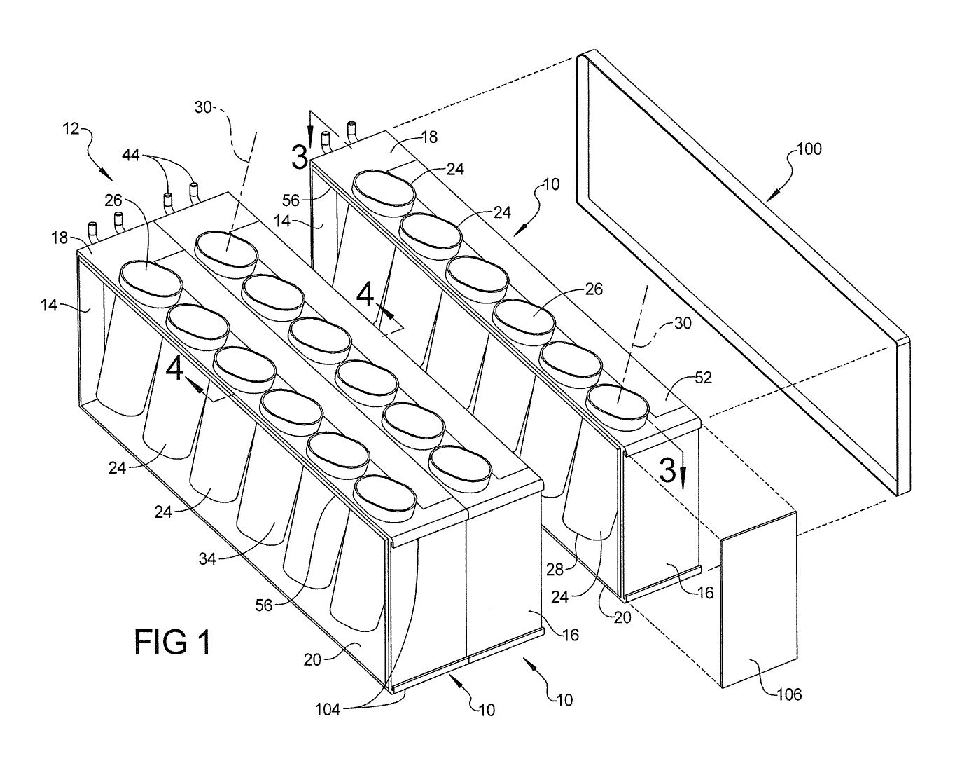

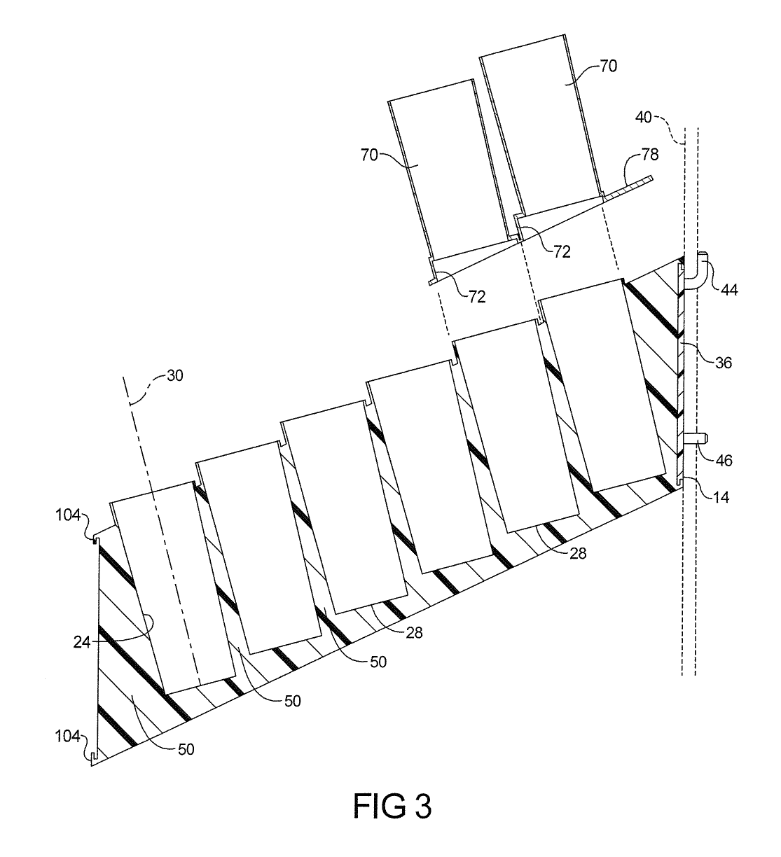

As shown in FIG. 1, a single modular display unit 10 formed of molded plastic, cardboard, fiberboard, plywood or any other suitable sheet material can be coupled to one or more similar or identical display units 10 to form an interconnected modular display system 12. Each display unit 10 is formed with a housing having a back wall 14, a front wall 16, a top wall 18 and a bottom wall 20. When the back wall 14 is mounted substantially flush against a vertical wall, such as on a pegboard, the top wall 18 slopes downwardly toward the front wall 16 such as shown in FIG. 3. In this manner, more surface area is available on the downwardly sloping top wall 18 per unit of horizontal length as measured from the back wall to the front wall as compared to a horizontally extending top wall.

This downwardly sloping roof design allows for easier viewing and easier physical access to products carried and presented by each unit 10. The downwardly sloping roof also reduces the length of outward projection of the unit 10 into the surrounding display area as compared to a horizontally projecting display unit having the same length of roof or floor as a comparable downwardly sloping roof or floor. This provides more floor clearance for shoppers and others.

As further seen in FIG. 1, one or more containers, cups or tubes 24 are provided in each unit 10. Each tube 24 has an open top portion 26 and a closed floor portion 28 serving as a bottom support portion for supporting and displaying elongated products, such as artists' paint brushes. The closed floor portion 28 can be spaced above the bottom wall 20. Alternatively, the floor portion 28 can be opened or eliminated so that a portion of the bottom wall 20 serves as a bottom support portion. To improve visibility and access to products disposed in the tubes 24, the longitudinal axis 30 and sidewalls 34 of the tubes 24 can be inclined forwardly from the floor portion 28 to the top portion 26, such as at an angle of 60 to 80 degrees. The containers 24 can be arranged in a series or in a row from the back wall to the front wall.

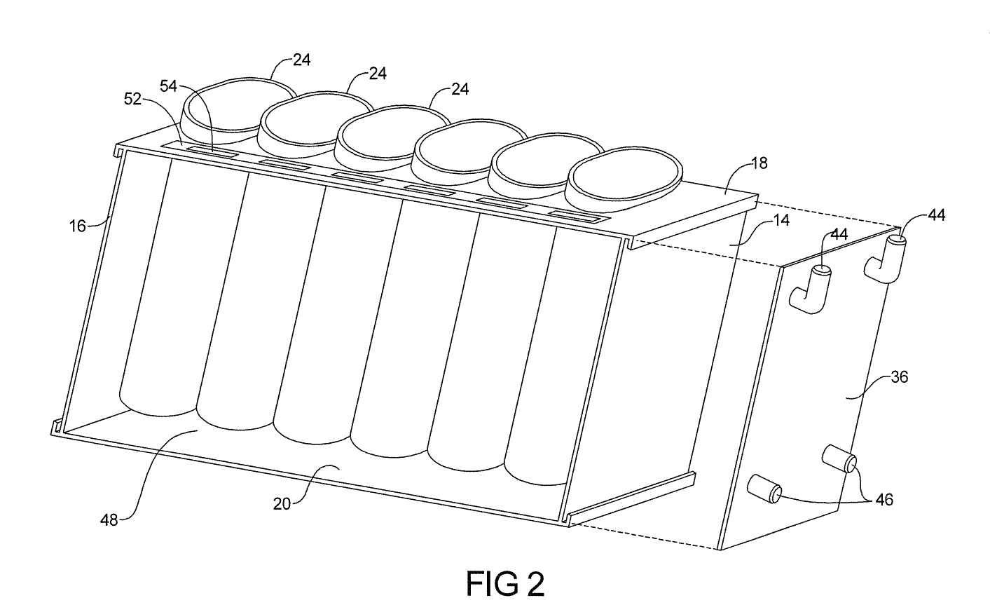

As seen in FIGS. 2 and 3, a rigid mounting plate 36 of molded plastic or fabricated sheet material is fixed to the exterior surface of the back wall 14. The mounting plate 36 includes a plurality of mounting pegs or hooks for removably mounting each unit 10 to a pegboard 40 (FIG. 3) or other surface having holes for receiving mounting pegs. For example, a pair of elbow-shaped cylindrical hooks 44 can be provided adjacent to an upper portion of the back wall 14, and a pair of straight cylindrical pegs 46 can be provided adjacent a lower portion of the back wall 14. The spacing and location of each hook 44 and peg 46 is set to correspond to the spacing of the openings on a standard pegboard.

As further seen in FIG. 2, a storage space or compartment 48 bordering the tubes 24 is defined between the front and rear walls 16, 14 and between the top wall and bottom walls 18, 20. This compartment 48 extends adjacent to the tubes 24 and provides a space for storage of extra products which can be used to replenish the products removed or purchased from the tubes 24. As shown in FIG. 3, a thin wall plastic section 50 can be molded between each tube 24 and extend from the top wall 18 to the bottom wall 20 and from the front wall 16 to the back wall 14 to provide additional structural strength and rigidity to each unit 10.

Different products can be placed in different tubes 24. A shallow recessed rectangular tray 52 can be formed on the outer surface of the top wall 18 to receive a strip or sheet of advertising or product information identifying each product in each tube 24.

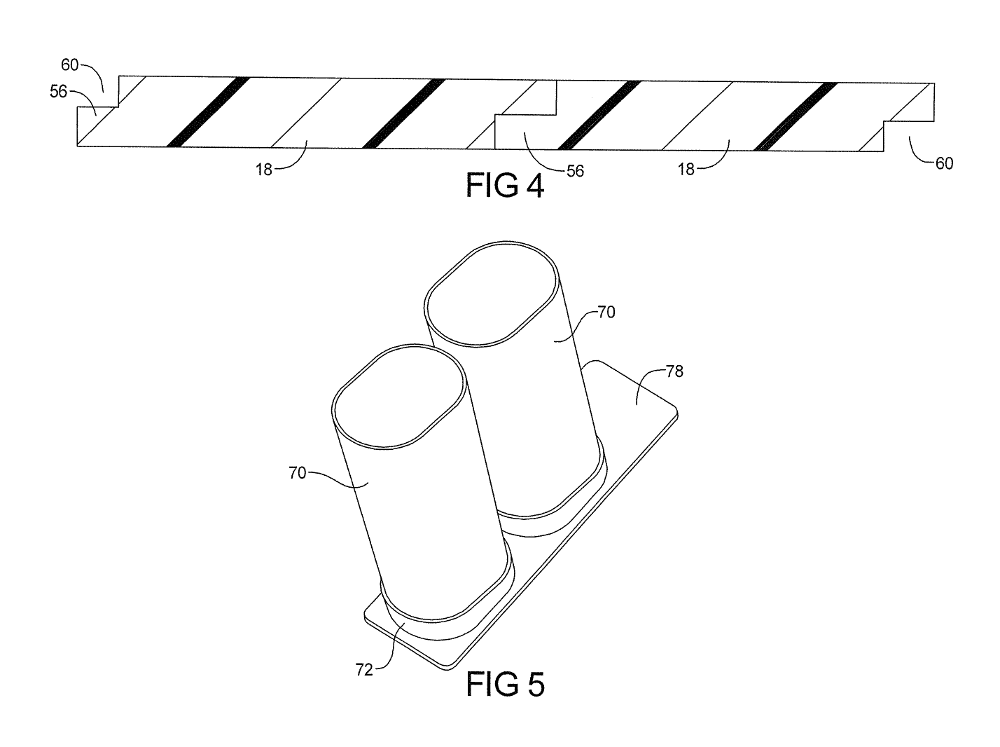

As noted above, each modular unit 10 can be coupled or connected to another modular unit 10 to form a display system 20. One form of interconnection is shown on one unit 10 in FIGS. 1 and 4, wherein a laterally extending tongue 56 slides into a laterally extending groove 60 on an adjacent unit 10 with a tight friction fit. Of course, other simple mechanical connections can be used such as tabs and slots, plugs and sockets and the like. The interconnections can be provided along or adjacent to one or more edges of one or more of the front, rear, top and bottom walls.

As further seen in FIGS. 1 and 3, the top portion 26 of each tube 24 projects above the top wall 18 to serve as a tubular connector or coupling portion for receiving one or more tubular extensions 70 (FIG. 5) with a simple axially sliding telescopic press fit. Each tubular extension 70 has a lower radially enlarged sleeve portion 72 (FIG. 3) that slides or telescopes over the top portion 26 of a tube 24 to center the sleeve portion 72 over the underlying tube 24. The tubular extension 70 can be provided as single tube or as several integral tubes formed of thin-walled molded plastic.

That is, two or more tubular extensions 70 may be provided as an integral assembly for coupling to two or more tubes 24. The tubular extensions 70 can be provided with a planar stabilizing platform 78 configured to lie flat on the top wall 18. The tubular extensions 70 can be easily installed and removed with a simple axial manual push and pull. Should it be required to display long-handled products or other elongated products, a tubular extension 70 can be easily coupled to a tube 24 for better supporting and aligning the displayed products.

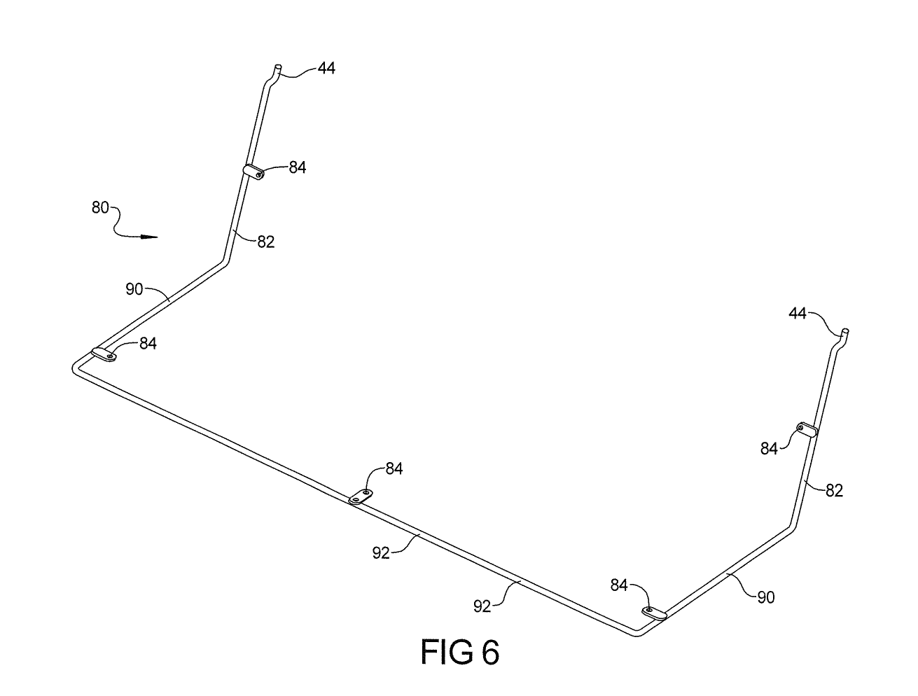

An alternate mounting arrangement to the individual mounting plates 36 is shown in FIG. 6 wherein a wire mounting bracket 80 is formed to complement the contours of a display unit 10 or a display system 12. A pair of back legs 82 has free end portions formed with elbow-shaped hooks 44 arranged to fit into the holes of a commercially available pegboard.

Mounting plates or tabs 84 are provided on each leg 82 for connecting the legs 82 to the back wall 14 of a respective display unit. A fastener such as a screw can be inserted through an aperture in each tab 84 and into the back wall 18 of a display unit to secure the bracket to a display unit 10 or to a display system 12. Additional tabs 84 can be provided on sides 90 of bracket 80 as well as on the front 92 of the bracket 80 for attachment to the bottom wall 20 of a display unit 10.

In some cases, it may be desirable to close the storage compartment 48 with a removable panel or sidewalk This is easily done by providing a removable side wall 100 as seen in FIG. 1. Side wall 100 can be provided along one or more of its four edges with a complementary tongue 50 and groove 60 of the type shown in FIG. 4 for mating with the tongues and grooves on the border around the compartment 48. Alternatively, flexible flanges 102 (FIG. 1) can be provided on side wall 100 to fit tightly around or within the compartment 48 and on the opposite side of the compartment 48 to close off either one or both sides of a unit 10. Advertising or other media or designs can be provided on the outside surface of side wall 100. Moreover, grooved rails 104 can be provided along the top and bottom of the front wall 16 to receive removable panels or placards 106 (FIG. 1) with a sliding sideways fit. The panels or placecards 106 can include product and marketing information, such as pictures, photos and/or descriptions of the products held in the respective tubes 24.

It will be appreciated by those skilled in the art that the above modular display system with compliant construction is merely representative of the many possible embodiments of the invention and that the scope of the invention should not be limited thereto, but instead should only be limited according to the following claims.

What is claimed is:

1. A modular display unit, comprising:
a housing having a front wall, a rear wall, a roof and a floor, said roof sloping downwardly from said rear wall towards said front wall with said rear wall extending vertically;
a plurality of containers disposed between said front and rear walls, each of said containers having a bottom support portion and an open top portion, said open top portion configured for coupling with a tubular extension for increasing the length of each of said containers; and
a plurality of pegboard hangers provided on said rear wall.

2. The display unit of claim 1, further comprising a storage area defined between said front and rear walls and between said roof and said floor, and extending adjacent to said plurality of containers.

3. The display unit of claim 1, further comprising a first side wall extending between said front and rear walls and between said roof and said floor, and extending adjacent to said plurality of containers.

4. The display unit of claim 3, wherein said first side wall comprises a removable side wall.

5. The display unit of claim 1, wherein said bottom support portion of said containers is spaced above said floor.

6. The display unit of claim 1, further comprising a connector comprising a tongue extending laterally from said roof.

7. The display unit of claim 1, further comprising a connector comprising a tongue extending laterally form said front wall.

8. The display unit of claim 1, further comprising a removable tubular extension fitted over said open top portion of at least one of said containers.

9. The display unit of claim 1, further comprising a removable placard disposed over said front wall.

10. A modular display system comprising:
a plurality of interconnected modular display units each comprising a plurality of containers adapted to receive a tubular extension;
a releasable connection between adjacent pairs of display units; and
a pegboard hanger for releasably mounting said system to a pegboard.

11. The system of claim 10, wherein each of said modular display units comprises a front wall, a rear wall and a roof slopping downwardly from said rear wall towards said front wall.

12. The system of claim 11, wherein said plurality of containers is disposed between said rear wall and said front wall.

13. The system of claim 11, wherein each of said containers further comprises a floor and a storage area defined between said front and rear walls and between said floor and said roof.

14. The system of claim 10, further comprising a removable tubular extension fitted over at least one of said containers.

15. The system of claim 10, wherein said pegboard hanger comprises a wire frame comprising a plurality of pegboard hooks.

16. The system of claim 10, further comprising a removable side wall connected to one of said modular display units.

17. The system of claim 10, further comprising a removable panel extending across a front portion of each of said plurality of modular display units.

18. The system of claim 10, further comprising a mounting plate connected to a rear portion of each of said plurality of containers and wherein said pegboard hanger is attached to said mounting plate.

19. The system of claim 10, further comprising a wire frame coupled to said modular display units and wherein said pegboard hanger is on said wire frame.
